(19) United States
(12) Patent Application Publication
(10) Pub. No.: US 2017/0361446 A1
(43) Pub. Date: Dec. 21, 2017

(54) Shock Absorption Structure of the Pneumatic Tool

(71) Applicants: Chih-Kuan Hsieh, Hemei Township (TW); Ping-Nan Huang, Taichung City (TW)

(72) Inventors: Chih-Kuan Hsieh, Hemei Township (TW); Ping-Nan Huang, Taichung City (TW)

(21) Appl. No.: 15/386,013

(22) Filed: Dec. 21, 2016

(30) Foreign Application Priority Data
Jun. 16, 2016 (TW) 105209064

(51) Int. Cl. B25D 17/24; B25D 9/04

(52) U.S. Cl. CPC B25D 17/24; B25D 9/04; B25D 2250/181; B25D 2217/0073

(57) ABSTRACT

A shock absorption structure of a pneumatic tool, the pneumatic tool contains: a body, a cylinder, a gas valve unit, an impact element, and an elastic unit. The body includes an air channel and a cavity having a closing face, an opening, and an air chamber. The body also includes a first orifice and a second orifice. The cylinder includes a sliding room, a contacting fringe, a defining cutout, and an air inlet. The gas valve unit is fixed between the sliding room and the contacting fringe. The impact element is disposed in the sliding room and is pushed by the high pressure gas to reciprocately move. The elastic unit includes an elastic pushing force and is secured in the air chamber so as to push against the closing face and the contacting fringe and to push the cylinder to move away from the grip handle.

### BACKGROUND OF THE INVENTION

### Field of the Invention

The present invention relates to a pneumatic tool, and more particularly to a shock absorption structure of the pneumatic tool.

### Description of the Prior Art

Conventional pneumatic tools contain a reciprocating pneumatic tool and a rotatable pneumatic tool, wherein the reciprocating pneumatic tool contains an impact element pushed by high pressure gas to repeatedly strike a workpiece, and the workpiece is driven to move reciprocately, thus cutting, punching, and drilling the workpiece.

With reference to FIG. 9, a conventional pneumatic tool contains a grip handle 10, a gas valve unit 20, a cylinder 30, and an impact element 40, wherein the grip handle 10 is coupled with an air inlet segment 101 configured to flow high pressure gas. The grip handle 10 also includes an air channel 102 communicating with the air inlet segment 101, a switch (not shown) configured to control the air inlet segment 101, and a cylindrical portion 103. The cylindrical portion 103 has a cavity 104 defined therein and communicating with the air channel 102. The gas valve unit 20 is fixed in the cavity 104 of the cylindrical portion 103, one end of the cylinder 30 inserts into the cavity 104 of the cylindrical portion 103 so that the cylinder 30 abuts against the gas valve unit 20. The cylinder 30 includes a sliding room 301 defined therein, a flowing passageway 302 formed between a front end of the sliding room 301 and the gas valve unit 20 so that the front end of the sliding room 301 is in communication with the gas valve unit 20 via the flowing passageway 302. The impact element 40 is movably accommodated in the sliding room 301 of the cylinder 30. After turning on the grip handle 10, the high pressure gas flows into the gas valve unit 20 of the cavity 104 of the cylindrical portion 103 from the air inlet segment 101 of the grip handle 10 via the air channel 102, hence the high pressure gas is controlled by the gas valve unit 20 flow from a rear end of the sliding room 301 of the cylinder 30 so as to push the impact element 40 to move toward a predetermined position to strike a workpiece (not shown), and the impact element 40 is stopped by the workpiece. Thereafter, the high pressure gas is controlled by the gas valve unit 20 to flow into a front end of the sliding room 301 of the cylinder 30 from the flowing passageway 302 so as to push the impact element 40 to move backward and to strike the gas valve unit 20, and the impact element 40 is stopped by the gas valve unit 30, hence the impact element 40 is pushed reciprocately to preform perform a predetermined operation.

However, as the impact element 40 of the conventional pneumatic tool is pushed backward to hit the gas valve unit 20, a reaction force passes toward user's hands repeatedly to cause using fatigue and to injure user's wrists.

To improve above-mentioned defects, a spring is accommodated in the cavity of the cylindrical portion so as to absorb vibration as the impact element 40 moves backward, thus reducing the reaction force which passes toward the user's hands. However, the spring cannot effectively reduce the reaction force which passes toward the user's hands, and the spring produces using fatigue and is replaced frequently.

The present invention has arisen to mitigate and/or obviate the afore-described disadvantages.

### SUMMARY OF THE INVENTION

The primary objective of the present invention is to provide a shock absorption structure of a pneumatic tool which contains the cylinder slidably disposed in the cavity of the body, the air chamber is defined in the cavity of the body, the air chamber accommodates the elastic unit, and when the impact element hits the air chamber backward, it drives the cylinder to move in the cavity, and the elastic unit and the air chamber press simultaneously so as to produce double shock absorption and to reduce a reaction force toward the user's hands, thus operating the pneumatic tool easily and protecting the user's wrists.

Another objective of the present invention is to provide a shock absorption structure of a pneumatic tool which contains the air chamber defined in the cavity of the body, and the air chamber accommodates the elastic unit and mates with the elastic unit so as to press simultaneously and to produce the double shock absorption, hence the elastic unit does not have elasticity fatigue and is not replaced often, after being used repeatedly.

Accordingly, a shock absorption structure of a pneumatic tool provided by the present invention contains: a body, a cylinder, a gas valve unit, an impact element, and an elastic unit.

The body includes an air channel configured to flow high pressure gas, and the body includes a cavity defined in the body, the cavity has a closing face formed on a first end thereof, and the cavity has an opening defined on a second end of the body opposite to the first end of the cavity. The body also includes a first orifice passing through the cavity, the body includes a second orifice communicating with the air channel and the cavity, and the first orifice accommodates a limitation element, a part of which extends to the cavity.

The cylinder is movably fixed in the cavity of the body and a part of the cylinder extends out of the body from the opening of the cavity. The cylinder includes a sliding room defined in the cylinder, and the cylinder includes a contacting fringe arranged on one end of the cylinder facing the closing face of the cavity of the fitting sleeve, the cavity of the body has an air chamber defined between the contacting fringe and the closing face. The cylinder has a defining cutout formed on an outer wall of the cylinder corresponding to the first orifice of the body, and the defining cutout accommodates a part of the limitation element which inserts through the first orifice, hence the cylinder straightly slides forward and backward within a predetermined range. The cylinder also includes an air inlet defined on the outer wall of the cylinder corresponding to the second orifice of the body, and the air inlet is in communication with the second orifice within a sliding range of the cylinder.

The gas valve unit is fixed between the sliding room of the cylinder and the contacting fringe so as to control a flowing direction of the high pressure gas.

The impact element is disposed in the sliding room of the cylinder and being pushed by the high pressure gas to move reciprocately.

The elastic unit includes an elastic pushing force and is secured in the air chamber of the body so as to push against the closing face of the cavity and the contacting fringe of the cylinder and to push the cylinder to move away from the grip handle.

### BRIEF DESCRIPTION OF THE DRAWINGS

FIG. 1 is a perspective view showing the exploded components of a pneumatic tool in accordance with a preferred embodiment of the present invention.

FIG. 2 is a perspective view showing the assembly of a slidable bushing of the pneumatic tool in accordance with the preferred embodiment of the present invention.

FIG. 3 is a perspective view showing the assembly of the pneumatic tool in accordance with the preferred embodiment of the present invention.

FIG. 4 is a cross sectional view showing the assembly of the pneumatic tool in accordance with the preferred embodiment of the present invention.

FIG. 5 is a cross sectional view showing an impact element being pushed forward by a pressure in accordance with the preferred embodiment of the present invention.

FIG. 6 is another cross sectional view showing the impact element being pushed forward by the pressure in accordance with the preferred embodiment of the present invention.

FIG. 7 is a cross sectional view showing the operation of the pneumatic tool in accordance with the preferred embodiment of the present invention.

FIG. 8 is another cross sectional view showing the operation of the pneumatic tool in accordance with the preferred embodiment of the present invention.

FIG. 9 is a cross sectional view of a conventional pneumatic tool.

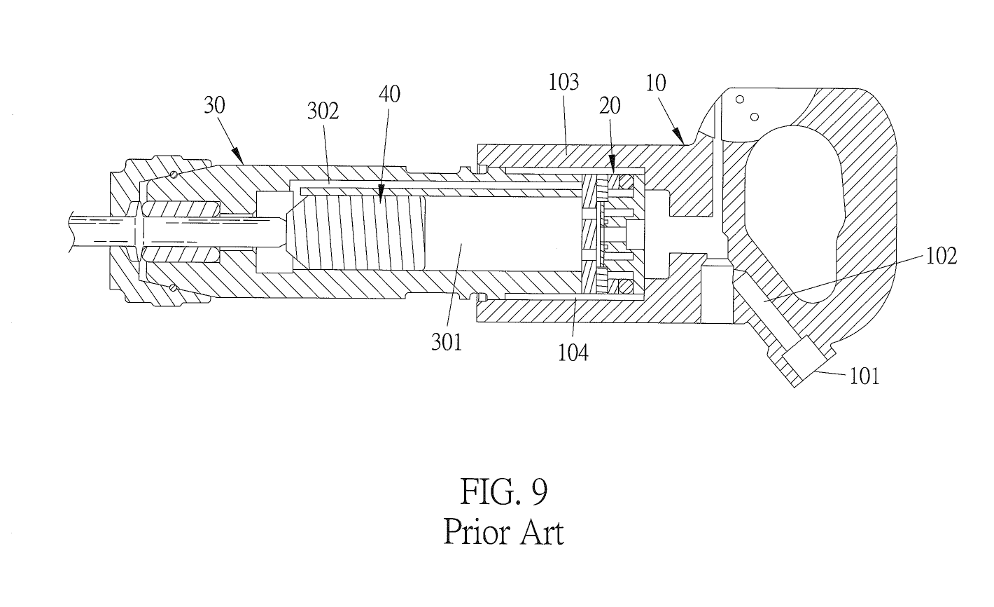

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

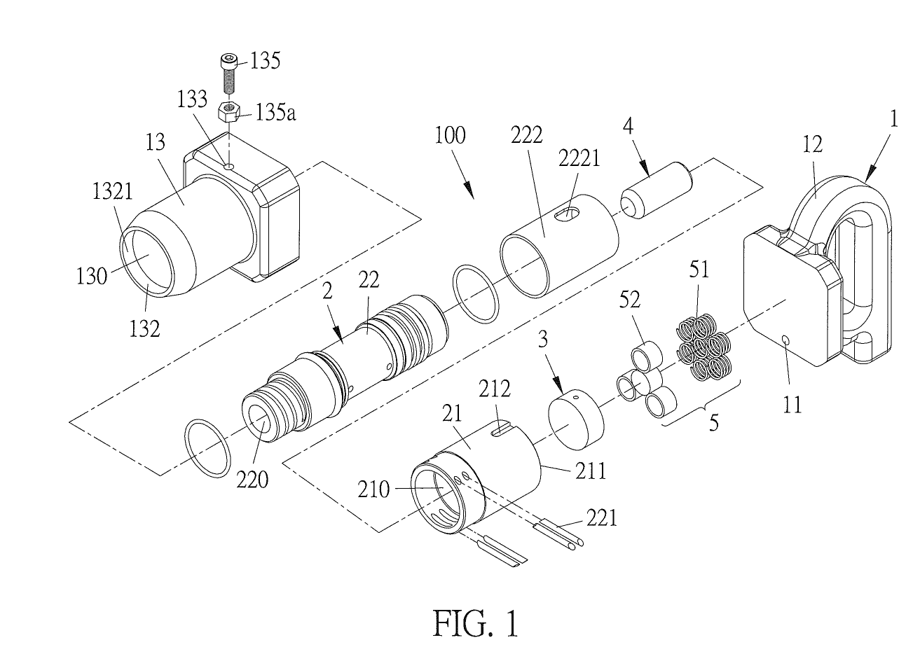

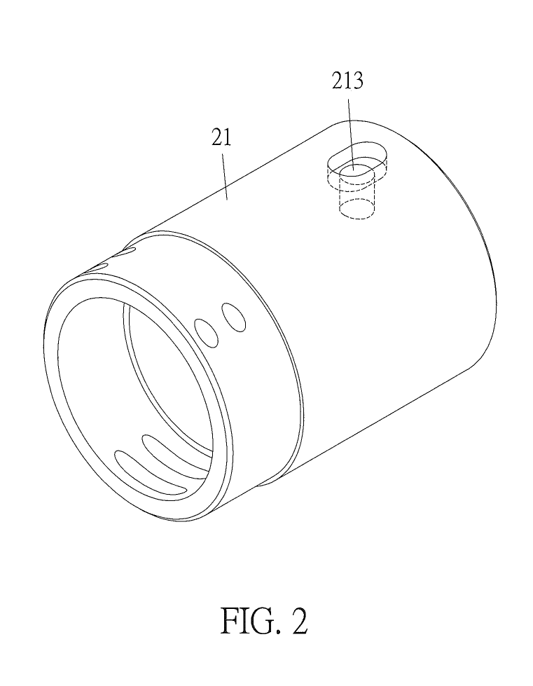

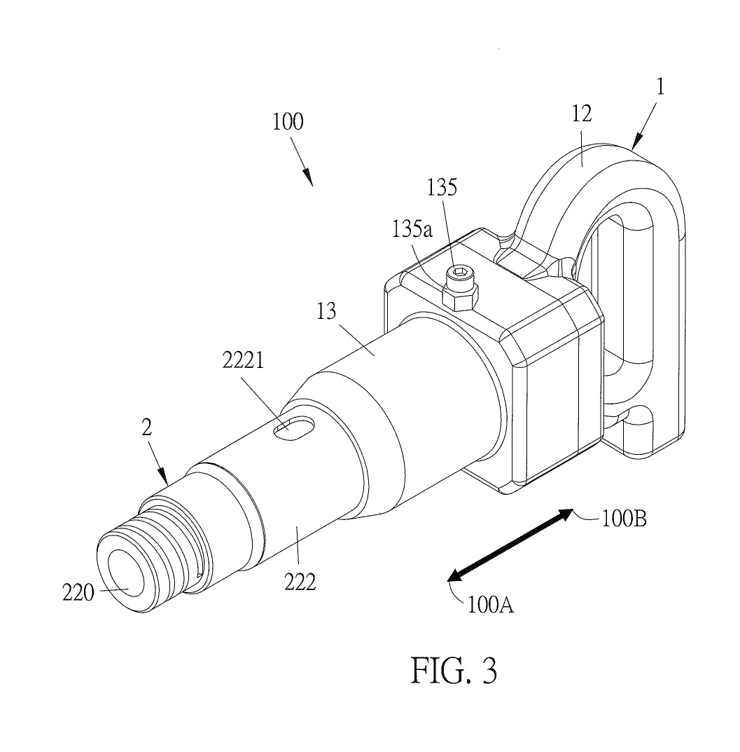

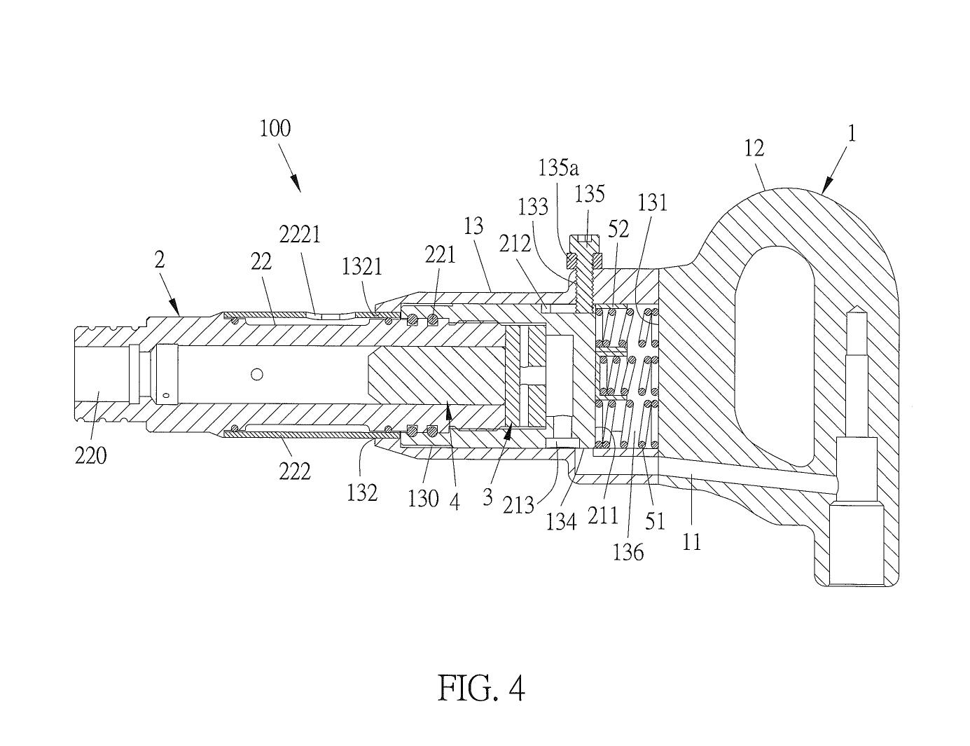

With reference to FIGS. 1 to 4, a shock absorption structure of a pneumatic tool 100 according to a preferred embodiment of the present invention, the pneumatic tool 100 comprises: a front side 100A and a rear side 100B, and the pneumatic tool 100 comprises a body 1, a cylinder 2, a gas valve unit 3, an impact element 4, and an elastic unit 5.

The body 1 includes an air channel 11 configured to flow high pressure gas, and the body 1 includes a grip handle 12 and a fitting sleeve 13 fitted with the grip handle 12, wherein the fitting sleeve 13 has a cavity 130 defined therein, the cavity 130 has a closing face 131 formed on a first end thereof and has an opening 132 defined on a second end thereof opposite to the first end of the cavity 130. The opening 132 has a shoulder 1321 extending inward therefrom, the fitting sleeve 13 has a first orifice 133 passing through the cavity 130 and has a second orifice 134 communicating with the air channel 11 and the cavity 130, wherein the first orifice 133 accommodates a limitation element 135 which screws with a fixing nut 135a and extends to the cavity 130 (In this embodiment, the limitation element 135 screws with the first orifice 133).

The cylinder 2 is comprised of a slidable bushing 21 and a hollow column 22, wherein the slidable bushing 21 is movably fixed in the cavity 130 of the fitting sleeve 13, and the fitting bushing 21 has a hollow portion 210 defined therein, the hollow portion 210 has a closed contacting fringe 211 arranged on one end thereof adjacent to the closing face 131 of the cavity 130 of the fitting sleeve 13. The cavity 130 of the body 1 has an air chamber 136 defined between the contacting fringe 211 and the closing face 131, the slidable bushing 21 has an elongated defining cutout 212 formed on an outer wall thereof corresponding to the first orifice 133 of the body 1, and the defining cutout 212 accommodates a part of the limitation element 135 which inserts through the first orifice 133, hence the slidable bushing 21 straightly slides forward and backward within a predetermined range and does not rotate. The slidable bushing 21 also has an air inlet 213 defined on the outer wall thereof corresponding to the second orifice 134 of the body 1 and communicating with the hollow portion 210, and the air inlet 213 is in communication with the second orifice 134 within a sliding range of the slidable bushing 21, wherein a first end of the hollow column 22 inserts into the hollow portion 210 of the slidable bushing 21 and retains with a bolt 221 in a screwing manner, and the first end of the hollow column 22 is connected with the slidable bushing 21 so that the hollow column 22 moves forward and backward in the cavity 130 of the fitting sleeve 13 with the slidable bushing 21. A part of a second end of the hollow column 22 extends out of the fitting sleeve 13 so as to connect with a workpiece (not shown) from the cavity 130 of the fitting sleeve 13, and the hollow column 22 has a sliding room 220.

The gas valve unit 3 is fixed between the hollow column 22 of the cylinder 2 and the contacting fringe 211 of the slidable bushing 21 so that the high pressure gas flows into the gas valve unit 3 from the air channel 11 of the body 1 via the second orifice 134 and the air inlet 213 of the slidable bushing 21, and the gas valve unit 3 controls a flowing direction of the high pressure gas (the gas valve unit 3 is a prior art, so further remarks are omitted).

The impact element 4 is disposed in the sliding room 220 of the hollow column 22 so as to reciprocately move forward and backward, after the impact element 4 is pushed by the high pressure gas.

The elastic unit 5 includes an elastic pushing force (in this embodiment, the elastic unit 5 are multiple springs 51 mating with multiple sheaths 52) and is secured in the air chamber 136 of the body 1 so as to push against the closing face 131 of the cavity 130 of the body 1 and the contacting fringe 211 of the cylinder 2 and to push the cylinder 2 to move away from the grip handle 12 (the front side 100A).

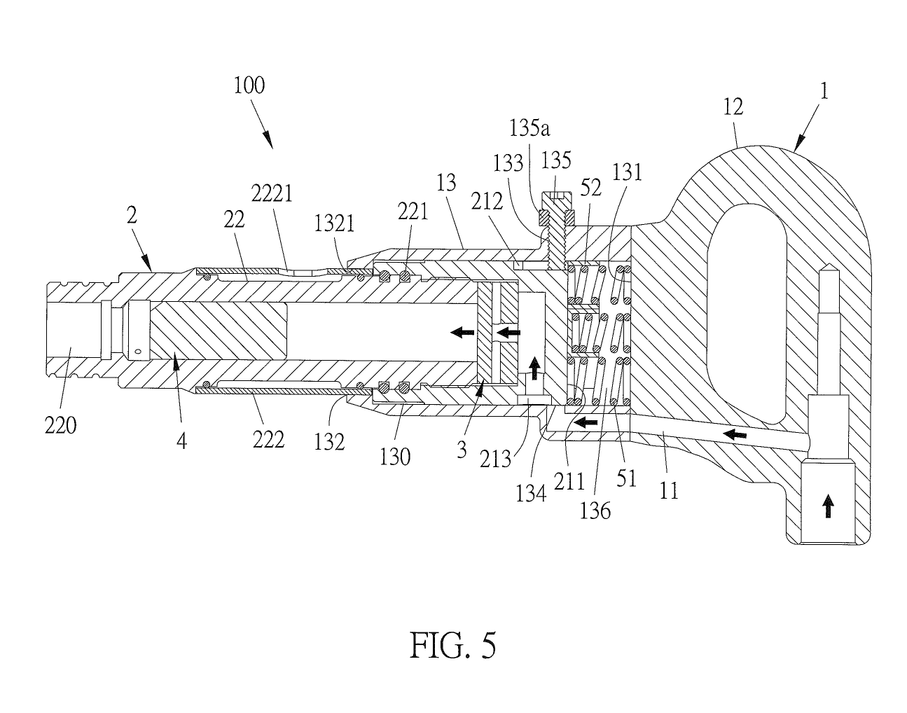

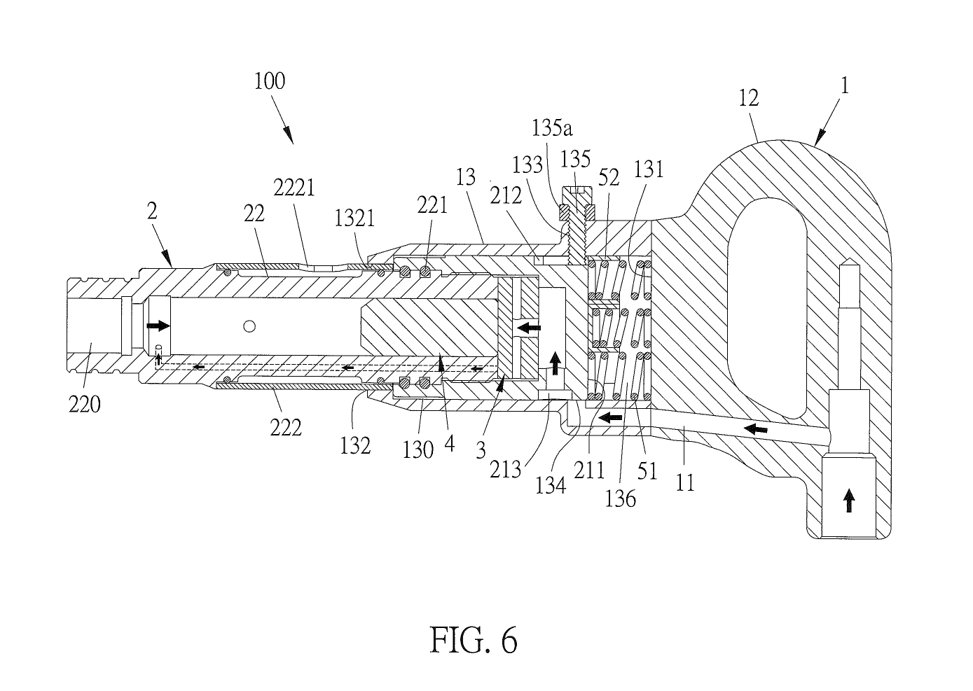

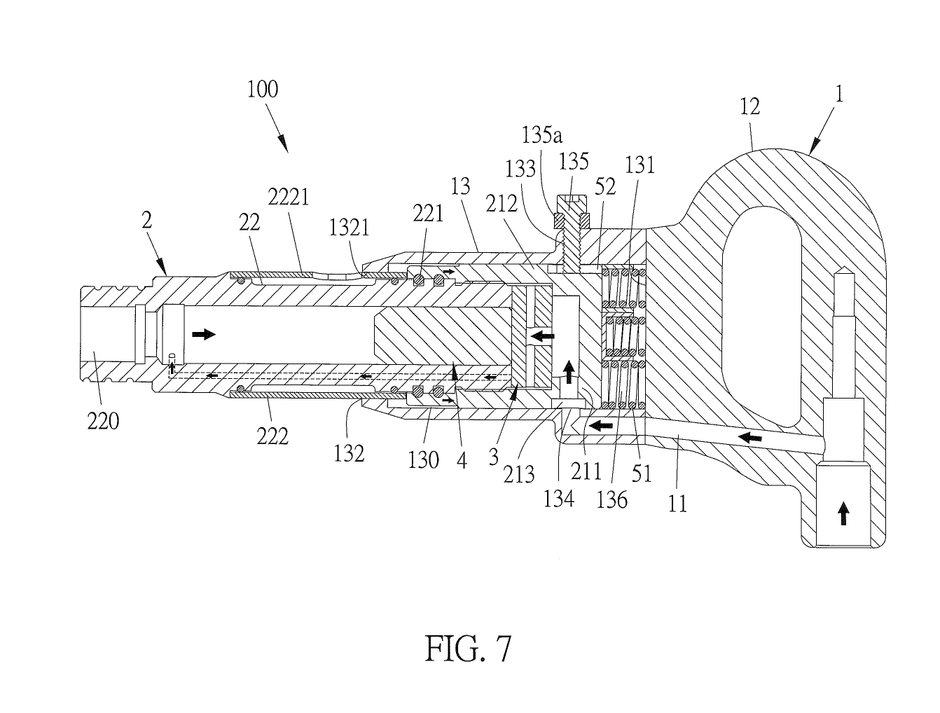

Referring further to FIG. 5, the air channel 11 of the body 1 is opened so that the high pressure gas flows into the gas valve unit 3 from the air channel 11 via the second orifice 134 and the air inlet 213 of the slidable bushing 21, and the high pressure gas flows into a rear end of the sliding room 220 of the hollow column 22 so as to push the impact element 4 to move toward a front end of the sliding room 220, hence the impact element 4 hits the workpiece (not shown) and is stopped by the workpiece. As illustrated in FIGS. 6 and 7, the high pressure gas is controlled by the gas valve unit 2 to flow into the front end of the sliding room 220 of the hollow column 22 and to push the impact element 4 to move backward toward the rear end of the sliding room 220, hence the impact element 4 hits the gas valve unit 3 and to drive the cylinder 2 to move backward, wherein the limitation element 135 limits a movement range of the cylinder 2 and to cooperate with the elastic unit 5 so as to press the air chamber 136, thus producing double shock absorption and reducing reaction force toward user's hands. Accordingly, the impact element 4 is reciprocately pushed forward and backward to perform a predetermined operation.

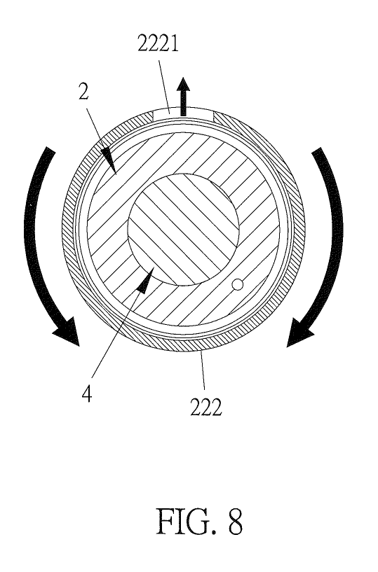

Referring further to FIG. 8, the hollow column 22 of the cylinder 2 has a rotatable adjustment bushing 222 fitted on the outer wall thereof, the rotatable adjustment bushing 222 has at least one air vent 2221 configured to exhaust the gas, and the rotatable adjustment bushing 222 is rotated so as to adjust a gas exhausting position, thus operating the pneumatic tool 100 smoothly.

Thereby, the shock absorption structure of the present invention has advantages as follows:

1. The cylinder 2 of the shock absorption structure is slidably disposed in the cavity 130 of the body 1, the air chamber 136 is defined in the cavity 130 of the body 1, the air chamber 136 accommodates the elastic unit 5, and when the impact element 4 hits the air chamber 136 backward, it drives the cylinder 2 to move in the cavity 130, and the elastic unit 5 and the air chamber 136 press simultaneously so as to produce the double shock absorption and to reduce the reaction force toward the user's hands, thus operating the pneumatic tool 100 easily and protecting the user's wrists.

2. The air chamber 136 is defined in the cavity 130 of the body 1 of the shock absorption structure, and the air chamber 136 accommodates the elastic unit 5 and mates with the elastic unit 5 so as to press simultaneously and to produce the double shock absorption, hence the elastic unit 5 does not have elasticity fatigue and is not replaced often, after being used repeatedly.

While we have shown and described various embodiments in accordance with the present invention, it is clear to those skilled in the art that further embodiments may be made without departing from the scope of the present invention.

What is claimed is:

1. A shock absorption structure of a pneumatic tool, the pneumatic tool comprising:
a body including an air channel configured to flow high pressure gas, and the body including a cavity defined in the body, the cavity having a closing face formed on a first end thereof, and the cavity having an opening defined on a second end of the body opposite to the first end of the cavity, the body also including a first orifice passing through the cavity, and the body including a second orifice communicating with the air channel and the cavity, the first orifice accommodating a limitation element, a part of which extends to the cavity;
a cylinder movably fixed in the cavity of the body and a part of the cylinder extending out of the body from the opening of the cavity, the cylinder including a sliding room defined in the cylinder, and the cylinder including a contacting fringe arranged on one end of the cylinder facing the closing face of the cavity of the fitting sleeve, the cavity of the body having an air chamber defined between the contacting fringe and the closing face, the cylinder having a defining cutout formed on an outer wall of the cylinder corresponding to the first orifice of the body, and the defining cutout accommodating a part of the limitation element which inserts through the first orifice, hence the cylinder straightly slides forward and backward within a predetermined range, the cylinder also including an air inlet defined on the outer wall of the cylinder corresponding to the second orifice of the body, and the air inlet being in communication with the second orifice within a sliding range of the cylinder;
a gas valve unit fixed between the sliding room of the cylinder and the contacting fringe so as to control a flowing direction of the high pressure gas;
an impact element disposed in the sliding room of the cylinder and being pushed by the high pressure gas to move reciprocately; and
an elastic unit including an elastic pushing force and being secured in the air chamber of the body so as to push against the closing face of the cavity and the contacting fringe of the cylinder and to push the cylinder to move away from the grip handle.

2. The shock absorption structure of the pneumatic tool as claimed in claim 1, wherein the body includes a grip handle and a fitting sleeve fitted with the grip handle.

3. The shock absorption structure of the pneumatic tool as claimed in claim 2, wherein the cavity, the first orifice, and the second orifice are defined in the fitting sleeve.

4. The shock absorption structure of the pneumatic tool as claimed in claim 1, wherein the opening of the cavity has a shoulder extending inward therefrom.

5. The shock absorption structure of the pneumatic tool as claimed in claim 1, wherein the cylinder is comprised of a slidable bushing and a hollow column, the slidable bushing is movably fixed in the cavity of the body, and the fitting bushing has a hollow portion defined therein, the closed contacting fringe is arranged on one end of the hollow portion adjacent to the closing face of the cavity of the fitting sleeve, the defining cutout and the air inlet are formed in the slidable bushing, and the air inlet passes through the hollow portion.

6. The shock absorption structure of the pneumatic tool as claimed in claim 1, wherein the cylinder is comprised of a slidable bushing and a hollow column, the slidable bushing is movably fixed in the cavity of the body, and the fitting bushing has a hollow portion defined therein, the closed contacting fringe is arranged on one end of the hollow portion adjacent to the closing face of the cavity of the fitting sleeve, the defining cutout and the air inlet are formed in the slidable bushing, and the air inlet passes through the hollow portion; a first end of the hollow column inserts into the hollow portion of the slidable bushing so that the hollow column moves forward and backward in the cavity of the fitting sleeve with the slidable bushing, and a part of a second end of the hollow column extends out of the fitting sleeve from the opening of the cavity, wherein the sliding room is defined in the hollow column.

7. The shock absorption structure of the pneumatic tool as claimed in claim 6, wherein the hollow column mates with a bolt to retain with the slidable bushing in a screwing manner.

8. The shock absorption structure of the pneumatic tool as claimed in claim 1, wherein the cylinder has a rotatable adjustment bushing fitted on the outer wall thereof, and the rotatable adjustment bushing has at least one air vent.

9. The shock absorption structure of the pneumatic tool as claimed in claim 1, wherein the limitation element screws with a fixing nut.
